(19) United States
(12) Patent Application Publication
(10) Pub. No.: US 2007/0130499 A1
(43) Pub. Date: Jun. 7, 2007

(54) DELIVERING WEB CONTENT IN A MESSAGE TRANSMITTED OVER A MOBILE WIRELESS COMMUNICATION NETWORK

(75) Inventor: Yun Sik Kim, Seoul (KR)

Correspondence Address: LEE, HONG, DEGERMAN, KANG & SCHMADEKA, 801 S. FIGUEROA STREET, 12TH FLOOR, LOS ANGELES, CA, 90017, US

(73) Assignee: LG ELECTRONICS INC.

(21) Appl. No.: 11/567,298

(22) Filed: Dec. 6, 2006

(30) Foreign Application Priority Data
Dec. 7, 2005 (KR) 10-2005-0118770

(51) Int. Cl. G06F 17/00; G06F 17/30; G06F 15/16

(52) U.S. Cl. 715/500.1; 715/513; 709/206; 707/1

(57) ABSTRACT

A mobile terminal having a limited browser for viewing content available on the Internet is provided. The mobile terminal in one embodiment comprises a conversion unit for converting web contents displayed by the limited browser into a multimedia message, the conversion unit comprising: a parser for parsing the web contents, an object extractor for extracting objects from the parsed web contents, and a multimedia message configurator for creating a multimedia message using the extracted objects.

### CROSS-REFERENCE TO RELATED APPLICATIONS

Pursuant to 35 U.S.C. § 119(a), this application claims the benefit of Korean Patent Application No. 10-2005-0118770, filed on Dec. 7, 2005, which is hereby incorporated by reference as if fully set forth herein.

### FIELD OF INVENTION

The present invention relates to multimedia messaging, and more particularly, to a system and a method for converting web contents into a multimedia message.

### BACKGROUND

A multimedia messaging service (hereinafter, referred to as “MMS”) allows a mobile terminal to send multimedia contents such as still images, moving images, characters or music. The MMS is developed from a short messaging service (SMS) for transmitting/receiving text and an enhanced messaging service (EMS) for transmitting/receiving simple graphics.

A user can transmit/receive postcards, still images, moving images, moving-image cards, maps or name cards using the MMS. The MMS supports a delivery of content such as a cartoon, an animation or a moving-image advertisement, which require a broadband connection. The MMS can transmit/receive complex multimedia contents such that a variety of content can be enjoyed using the mobile terminal. Accordingly, the MMS is being expected to become a major messaging service for substituting for the SMS in a third-generation mobile communication network environment.

In order to create and efficiently display a multimedia message, a multimedia message markup language is used. A representative example of the multimedia message markup language is synchronized multimedia integration language (SMIL), which may be defined as a multimedia integration language composed of several simple tags and attributes or a multimedia layout language suggested by world wide web consortium (W3C)'.

The SMIL defines a standard and a transmission technology for expressing synchronized multimedia contents including sound, moving images and text. The SMIL is not compiled into a single file. The multimedia files including sound, moving images and text are stored as individual files and the SMIL combines the multimedia files such that the multimedia files are displayed in a multimedia presentation format.

A mobile communication terminal can wirelessly access the Internet over a wireless mobile communication network such as a cellular network. A user of the mobile terminal can surf/search web contents such as a web page using an Internet browser of a mobile terminal, such as a cellular telephone.

Currently, web contents such as news or weather information cannot be forwarded to a third party while a user of a mobile terminal is wirelessly surfing and searching the web via the limited browser software installed on the mobile terminal. This is because the multimedia message markup language such as the SMIL requires text image, sound and video to be separately stored as independent objects, such that style information for each object cannot be converted to multimedia data.

Unfortunately, the multimedia message markup language is not compatible with an Internet markup language, such as a Wireless Markup Language (WML) or an eXtended Hypertext Markup Language (XHTML) utilized in mobile terminals. Since web contents implemented by the WML or the XHTML, which is the markup language including the style information, cannot be transmitted due to incompatibility with the multimedia message markup language, new methods and systems are needed to overcome the above-noted problems.

### SUMMARY

Features and advantages of the invention will be set forth in the description which follows, and in part will be apparent from the description, or may be learned by practice of the invention. The objectives and other advantages of the invention will be realized and attained by the structure particularly pointed out in the written description and claims hereof as well as the appended drawings.

To achieve these and other advantages and in accordance with the purpose of the present invention, as embodied and broadly described, a unit for extracting web content displayed in a browser of a limited display device is provided. The unit comprises a parser for parsing the web content; and an object extractor for extracting one or more objects from the parsed web content such that the extracted objects can be included in a multimedia message transmitted over a wireless mobile communications network.

The unit for extracting web content may further comprise a multimedia message configurator for the including the extracted objects in a multimedia message for transmission over a wireless mobile communications network. In one embodiment, the web content comprises wireless application protocol (WAP) contents and the multimedia message comprises synchronized multimedia integration language (SMIL) contents.

In one embodiment, the object extractor comprises a text extractor for extracting a text object from the parsed web contents, an image extractor for extracting an image object from the parsed web contents; and a sound extractor for extracting a sound object from the parsed web contents. In one embodiment the WAP contents are implemented in a Wireless Markup Language (WML) or an eXtended Hypertext markup Language (XHTML).

In accordance with another aspect of the invention, a method for transmitting web contents displayed in a browser of a limited display device is provided. The method comprises parsing the web contents to detect objects associated with the web contents displayed in the browser of the limited display device; extracting the objects from the parsed web contents; and configuring a multimedia message to comprise the extracted objects. The extracting may comprise extracting a text object from the parsed web contents extracting an image object from the parsed web contents; and extracting a sound object from the parsed web contents.

In accordance with yet another embodiment, a mobile terminal having a limited browser for viewing content available on the Internet is provided. The mobile terminal comprises a conversion unit for converting web contents displayed by the limited browser into a multimedia message, the conversion unit comprising a parser for parsing the web contents, an object extractor for extracting objects from the parsed web contents, and a multimedia message configurator for creating a multimedia message using the extracted objects. The mobile terminal may also comprise a multimedia message transmitter for transmitting the multimedia message.

In one embodiment, the object extractor comprises at least one of a text extractor for extracting a text object from the parsed web contents; an image extractor for extracting an image object from the parsed web contents; and a sound extractor for extracting a sound object from the parsed web contents, wherein the WAP contents are implemented in at least one of WML or XHTML format.

These and other embodiments of the present invention will also become readily apparent to those skilled in the art from the following detailed description of the embodiments having reference to the attached figures, the invention not being limited to any particular embodiments disclosed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a schematic block diagram showing a mobile terminal, according to one embodiment.

FIG. 2 is a schematic block diagram showing a web contents/multimedia message conversion unit in accordance with one embodiment.

FIG. 3 is a flowchart illustrating a method for converting web contents into a multimedia message according to one embodiment.

FIG. 4 illustrates exemplary screen shots of a mobile terminal according to one embodiment.

Reference will now be made in detail to the preferred embodiments of the present invention, examples of which are illustrated in the accompanying drawings. Features, elements, and aspects of the invention that are referenced by the same numerals in different figures represent the same, equivalent, or similar features, elements, or aspects in accordance with one or more embodiments of the system.

### DETAILED DESCRIPTION OF PREFERRED EMBODIMENTS

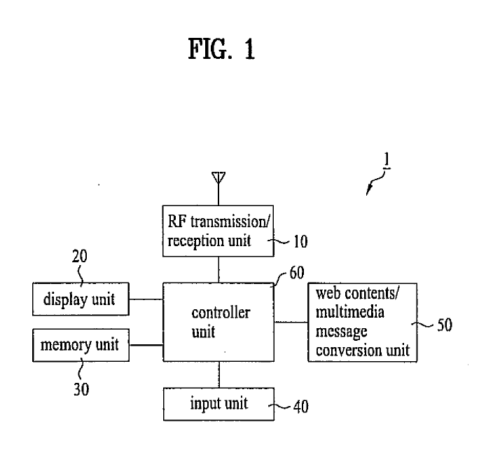

Referring to FIG. 1, a mobile terminal according to one embodiment of the present invention is provided. Preferably, the mobile terminal 1 includes an RF transmission/reception unit 10, a display unit 20, a memory unit 30, an input unit 40, a web contents/multimedia message conversion unit 50, and a control unit 60.

The RF transmission/reception unit 10 can allow the mobile terminal to communicate with an external device over a wireless mobile communication network. Specifically, the RF transmission/reception unit 10 can provide access to web contents over the mobile communication network. The RF transmission/reception unit 10 functions as a multimedia message transmitter for transmitting multimedia messages which can be implemented according to one embodiment of the invention, as provided below.

The display unit 20 displays the operational status of various functions provided by the mobile terminal 1 on a display screen. Specifically, the display unit 20 displays a mobile Internet browser (for example, a wireless application protocol (WAP) browser) for surfing/searching web contents.

The memory unit 30 stores software for driving the various functions provided of mobile terminal 1 and various kinds of data. The input unit 40 allows a terminal user to input various kinds of commands or information into the mobile terminal 1. A web contents/multimedia message conversion unit 50 converts the web contents accessed by an Internet browser of the mobile terminal 1 into multimedia messages as provided below.

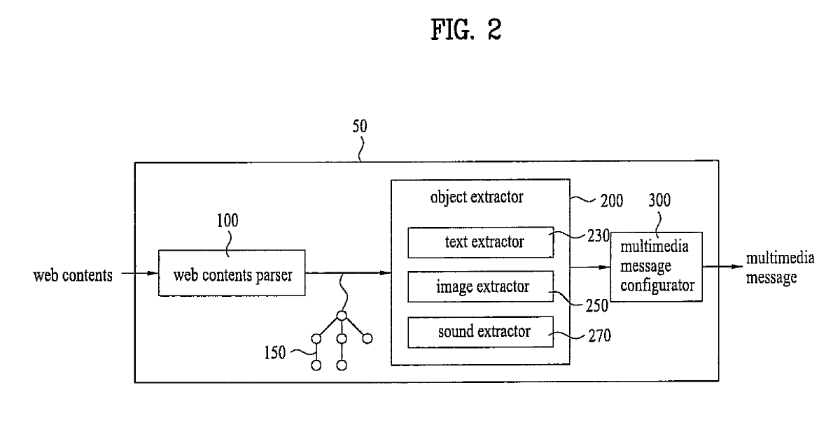

In one embodiment, the control unit 60 controls the RF transmission/reception unit 10, the display unit 20, the memory unit 30, the input unit 40, and the web contents/multimedia message conversion unit 50. In accordance with one embodiment, web contents/multimedia message conversion unit 50 will be described in detail with reference to FIG. 2 as provided below.

As shown, the web contents/multimedia message conversion unit 50 comprises a web contents parser 100, an object extractor 200, and a multimedia message configurator 300. The object extractor 200 comprises a text extractor 230, an image extractor 250 and a sound extractor 270.

The web contents which are desired to be transmitted from a first mobile terminal to a second mobile terminal are input to the web contents parser 100. The web contents may be wireless application protocol (WAP) contents implemented by a Wireless Markup Language (WML) or an eXtended Hypertext Markup Language (XHTML).

The web contents parser 100 parses the inputted web contents and arranges the parsed web contents in a tree structure, for example, as shown by reference numeral 150 in FIG. 2. The web contents arranged in the tree structure are inputted to the object extractor 200. The text extractor 230, the image extractor 250 and the sound extractor 270 of the object extractor 200 extract a text object, an image object and a sound object from the WAP contents arranged in the tree structure, respectively. In one embodiment the object extractor is a software module of a WAP browser, for example.

The extracted text objects, image objects and sound objects are input to the multimedia message configurator 300. The multimedia message configurator configures a multimedia message using the extracted objects. The configured multimedia message is preferably implemented from synchronized multimedia integration language (SMIL) contents using a SMIL as a multimedia message marlkup language. The multimedia message configurator 300 may be a software module of a multimedia message service function. The configured multimedia message can be transmitted to the second mobile terminal or other destination via the RF transmission/reception unit 10 shown in FIG. 1.

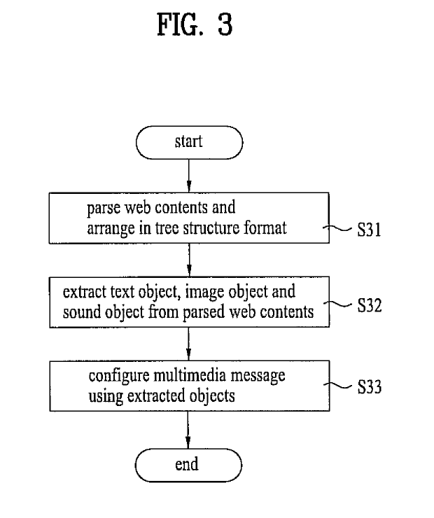

Hereinafter, a method for transmitting web contents using a multimedia message according to one embodiment of the invention will be described with reference to FIG. 3. FIG. 3 is a flowchart illustrating a method for converting web contents into a multimedia message.

Web contents which are desired to be transmitted from the mobile terminal to a destination by way of a multimedia message are parsed and arranged in a tree structure format for example (S31). As such, at least one of a text object, image object and sound object are extracted from the web contents (S32). The multimedia message is configured using the extracted text object, image object or sound object. In an exemplary embodiment, the multimedia message is constructed in SMIL format (S33).

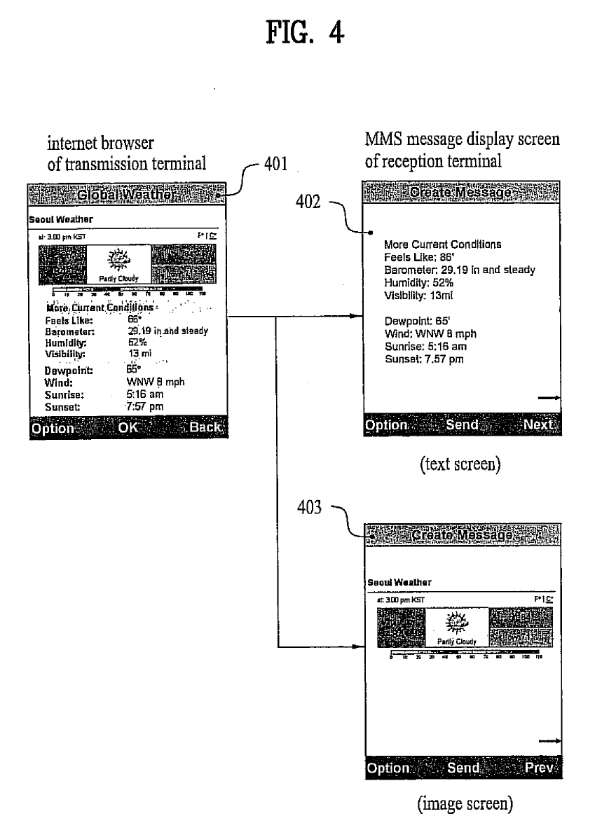

Referring to FIG. 4, a terminal user may, for example, transmit web contents which are displayed on an Internet browser screen 401 of a mobile terminal in form of a multimedia message. An exemplary display screen of a terminal which receives the transmitted multimedia message is illustrated on screens 402 and 403 where the transmitted multi media message displayed. In the exemplary illustration in FIG. 4, the multimedia message display screen 402 displays a text object and multimedia message display screen 403 displays and image object received in an MMS message sent from the transmitting mobile terminal.

As described above, the present invention provides a technology for transmitting web contents displayed on a limited display of a mobile communication terminal. Therefore, according to the present invention, it is possible to easily transmit a variety of web contents while wirelessly surfing the web.

It will be apparent to those skilled in the art that various modifications and variations can be made in the present invention without departing from the spirit or scope of the inventions. Thus, it is intended that the present invention covers the modifications and variations of this invention provided they come within the scope of the appended claims and their equivalents.

What is claimed is:

1. A unit for extracting web content displayed in a browser of a limited display device, the unit comprising:
a parser for parsing the web content; and
an object extractor for extracting one or more objects from the parsed web content such that the extracted objects can be included in a multimedia message transmitted over a wireless mobile communications network.

2. The unit of claim 1, further comprising a multimedia message configurator for the including the extracted objects in a multimedia message for transmission over a wireless mobile communications network.

3. The unit according to claim 1, wherein the web content comprises wireless application protocol (WAP) contents.

4. The unit according to claim 1, wherein the multimedia message comprises synchronized multimedia integration language (SMIL) contents.

5. The unit according to claim 1, wherein the object extractor comprises a text extractor for extracting a text object from the parsed web contents.

6. The unit according to claim 1, wherein the object extractor comprises an image extractor for extracting an image object from the parsed web contents.

7. The unit according to claim 1, wherein the object extractor comprises a sound extractor for extracting a sound object from the parsed web contents.

8. The unit according to claim 1, wherein the object extractor comprises:
a text extractor for extracting a text object from the parsed web contents;
an image extractor for extracting an image object from the parsed web contents; and
a sound extractor for extracting a sound object from the parsed web contents.

9. The unit according to claim 3, wherein the WAP contents are implemented in a Wireless Markup Language (WML).

10. The unit according to claim 3, wherein the WAP contents are implemented in an eXtended Hypertext markup Language (XHTML).

11. A method for transmitting web contents, displayed in a browser of a limited display device, in a multimedia message, the method comprising:
parsing the web contents to detect objects associated with the web contents displayed in the browser of the limited display device;
extracting the objects from the parsed web contents; and
configuring a multimedia message to comprise the extracted objects.

12. The method according to claim 11, wherein the web contents comprise WAP contents.

13. The method according to claim 11, wherein the multimedia message is SMIL contents.

14. The method according to claim 11, wherein the extracting comprises extracting a text object from the parsed web contents.

15. The method according to claim 11, wherein the extracting comprises extracting an image object from the parsed web contents.

16. The method according to claim 11, wherein the extracting comprises extracting a sound object from the parsed web contents.

17. The method according to claim 11, wherein the extracting comprises.
extracting a text object from the parsed web contents;
extracting an image object from the parsed web contents; and
extracting a sound object from the parsed web contents.

18. The method according to claim 12, wherein the WAP contents are implemented in form of a Wireless Markup Language (WML).

19. The method according to claim 12, wherein the WAP contents are implemented in form of an eXtended Hypertext markup Language (XHTML).

20. A mobile terminal having a limited browser for viewing content available on the Internet, the mobile terminal comprising:
a conversion unit for converting web contents displayed by the limited browser into a multimedia message, the conversion unit comprising:
a parser for parsing the web contents,
an object extractor for extracting objects from the parsed web contents, and
a multimedia message configurator for creating a multimedia message using
the extracted objects.

21. The mobile terminal of claim 20 comprising a multimedia message transmitter for transmitting the multimedia message.

22. The mobile terminal according to claim 20, wherein the web contents comprise WAP contents.

23. The mobile terminal according to claim 20, wherein the multimedia message comprises SMIL contents.

24. The mobile terminal according to claim 20, wherein the object extractor comprises at least one of:
a text extractor for extracting a text object from the parsed web contents;
an image extractor for extracting an image object from the parsed web contents; and
a sound extractor for extracting a sound object from the parsed web contents.

25. The mobile terminal according to claim 22, wherein the WAP contents are implemented in at least one of WML or XHTML format.
